(19) United States
(12) Patent Application Publication
(10) Pub. No.: US 2022/0125017 A1
(43) Pub. Date: Apr. 28, 2022

(54) Pet Management System

(71) Applicant: Kimberly Langenbach, San Francisco, CA (US)

(72) Inventor: Kimberly Langenbach, San Francisco, CA (US)

(21) Appl. No.: 17/175,807

(22) Filed: Feb. 15, 2021

Related U.S. Application Data
(60) Provisional application No. 63/106,563, filed on Oct. 28, 2020.

(51) Int. Cl. A01K 27/00

(52) U.S. Cl. CPC A01K 27/003; A01K 27/009; A01K 27/008

(57) ABSTRACT

This present invention relates to domesticated animal accessory, and more particularly to a singular pet management system that can be used to control, feed, train and/or clean up after a pet, such as a dog. The pet management system is comprised of a leash having first and second ends, a handle positioned on the first end, a collar connecting mechanism positioned on the second end, a generally “V” shaped receptacle, a sound emitting device, and a waste management system, all easily accessible to the user. The receptacle may be used to hold consumable products (e.g., dog treats) or any other item that the user may need to transport, and the sound emitting device may be used to train the animal attached to the leash.

### CROSS-REFERENCE TO RELATED APPLICATION

The present application claims priority to, and the benefit of, U.S. Provisional Application No. 63/106,563, which was filed on Oct. 28, 2020 and is incorporated herein by reference in its entirety.

### FIELD OF THE INVENTION

The present invention relates to the field of pet accessories. More particularly, the present invention relates to a device used for the training and protection of domesticated animals, such as dogs or other pets that may be trained or walked on a leash. The device is preferably comprised of a pet leash, an associated bag for holding a pet treat or the like in conjunction with the leash, and a sound emitting device to facilitate training and/or control of the pet and also incorporated into the leash. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

There are many different pet products available on the market today. Such pet products range from pet toys to training accessories, and may be purchased on-line or at various retail establishments. Domesticated pets, such as dogs, have long been a loyal companion to mankind and are beloved by their owners. Where pets live in an urban or suburban setting, it is often necessary to take the pet for a walk for exercise, as well as to reinforce certain behaviors, such as remaining close to the owner and not pulling or chasing after other pets, people, wildlife, cars, or the like. Many communities also have laws, regulations or ordinances that require that a pet, such as a dog, be on a leash when on public property, or otherwise out in public. Failure to abide by such leash laws may result in the pet owner or caretaker incurring fines. Further, a pet owner or caretaker may be civilly liable if their pet bites or otherwise harms another person or pet, or if the pet causes property damage. Accordingly, it is important for pet owners and caretakers to have control over their pets when out in public.

By way of background, pet leashes typically include a length of leash, such as an elongated strap or chain, having a proximal end and a distal end. A handle is typically positioned on the proximal end of the leash so that the owner can hold on to the leash. More specifically, the handle normally has a loop or other structure that the owner can slip his or her hand through so that the loop is around the wrist of the owner, and the owner's hand can hold the leash. At the distal or opposite end of the leash is typically a latch or other device that connects the leash to a loop or other connection point on the collar of the pet.

Despite their usefulness, pet leashes are normally single function devices. More specifically, the pet leash serves the singular purpose of enabling the pet owner or caretaker to physically contain the pet, for example, while walking the pet in public. However, due to various municipal laws, regulations and ordinances, pet owners are not only required to maintain control of their pets, but to also to clean up after their pets. While a pet leash can easily help maintain control of the animal, single use products are not effective in helping to clean up after the pet or provide any other functionality, such as may be required to help in feeding, rewarding and/or training the animal.

Therefore, there exists a long felt need in the art for an improved pet leash that serves more than one discrete function. There is also a long felt need in the art for a singular pet management system that has multiple functionalities, such as providing the pet owner and/or caretaker with the ability to not only control the animal, but to also reward and/or train the animal. Moreover, there is a long felt need in the art for a singular pet management system that enables the pet owner and/or caretaker to abide by various laws, regulations and ordinances without the need to carry multiple pet related instrumentalities. Finally, there is a long felt need in the art for a singular pet management system that is relatively inexpensive to manufacture, environmentally friendly, and that is both safe and easy to use.

The creation of a multi-faceted pet management system gives a pet owner and/or caretaker a single device that can assist in the control, training, feeding and/or clean up of the animal. In this manner, the improved pet management system of the present invention accomplishes all of the forgoing objectives, and substantially departs from the concepts and designs of the conventional.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

This invention relates to domesticated animal accessories, and more particularly to a multi-faceted pet management system that can be used by a pet owner and/or caretaker for the control of a pet, such as a dog, as well as to facilitate the rewarding and/or training of the pet. The pet management system of the present invention preferably comprises a strip of material having a proximal end and an opposing distal end, a handle, a collar connecting mechanism, and a sound emitting device. The handle is positioned on the proximal end of the strip of material in the general shape of a loop, and the collar connecting mechanism is positioned on the opposing distal end. A portion of the loop shaped handle further forms a “V” shaped receptacle that has one or more pockets to hold consumable products (e.g., dog treats), and other items (e.g., animal waste bags or accessories). Additionally, the noise emitting device is positioned along the handle, preferably adjacent to the “V” shaped receptacle, for convenient access by the pet owner and/or caretaker, and is useful in assisting the pet owner and/or caretaker in the training and management of the animal.

In one exemplary embodiment, a pet management device is described. The pet management device is preferably comprised of a leash having a first end and a second end, with the first end including a connection point for securing the leash to a collar of a pet, such as a dog, and a second end for aiding a pet owner and/or caretaker in retaining the leash. The leash has a length of material between the first and second ends, with the second end having at least one pocket, a sound emitting device and a loop.

In a still further exemplary embodiment, a domesticated pet leash is presented. The domesticated pet leash includes a length of material, such as a strap, chain, etc., having first and second ends, wherein the second end is comprised of a handle and the first end is comprised of a connection point to a collar for a pet. The second end is further comprised of a generally “V” shaped receptacle disposed adjacent to the handle, with the generally “V” shaped receptable having a narrow end and a broader end. The narrow end receives the length of material, and the broader end forms a base of a loop for the handle. The broader end is further comprised of an opening with a closure, and the generally “V” shaped receptacle is comprised of a first wall and a second wall.

In a yet still further exemplary embodiment, a pet training device is disclosed. The pet training device is comprised of an extensible leash having first and second ends. A select one of the first and second ends is comprised of an integrated receptacle that includes first and second pockets. Additionally, the same end of the extensible leash that includes the integrated receptacle may further comprise a noise making device and a waste management feature. The noise making device is useful in assisting the pet owner and/or caretaker to properly train the pet, and the waste management feature enables the pet owner and/or caretaker to properly clean up after the pet (e.g., after the pet defecates).

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a user using one potential embodiment of the pet management system of the present invention in accordance with the disclosed architecture and in relation to the training of a pet;

FIG. 2 illustrates a partial perspective view of the user using one potential embodiment of the pet management system of the present invention in accordance with the disclosed architecture and in relation to the rewarding or feeding of the leashed pet;

FIG. 3 illustrates a partial perspective view of one potential embodiment of the handle portion of the pet management system of the present invention in accordance with the disclosed architecture;

FIG. 4 illustrates a partial perspective view of one potential embodiment of the generally “V” shaped receptacle of the pet management system of the present invention in accordance with the disclosed architecture, and containing a plurality of dog treats therein; and

FIG. 5 illustrates a partial perspective view of one potential embodiment of the second pocket of the generally “V” shaped receptacle of the pet management system of the present invention in accordance with the disclosed architecture, and a key being placed therein.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

The present invention, relates to a pet management system that allows a pet owner, such as the owner of a dog, to not only maintain control of the animal, but also to be equipped with other features to help manage the ownership of the pet. For example, the present invention may include a noise emitting device, such as a squeaker or clicker, that is intended to garner the attention of the animal and to distract the pet from engaging in activities which are not desired. In addition, the pet management system of the present invention may include a waste management feature such as for the collection of a pet stool when the pet defecates in a public area. The pet management device may also include one or more pockets to hold consumable pet products, such as pet biscuits, cookies and the like, as well as things that may be needed by the owner, such as keys, credit cards, ID cards and the like.

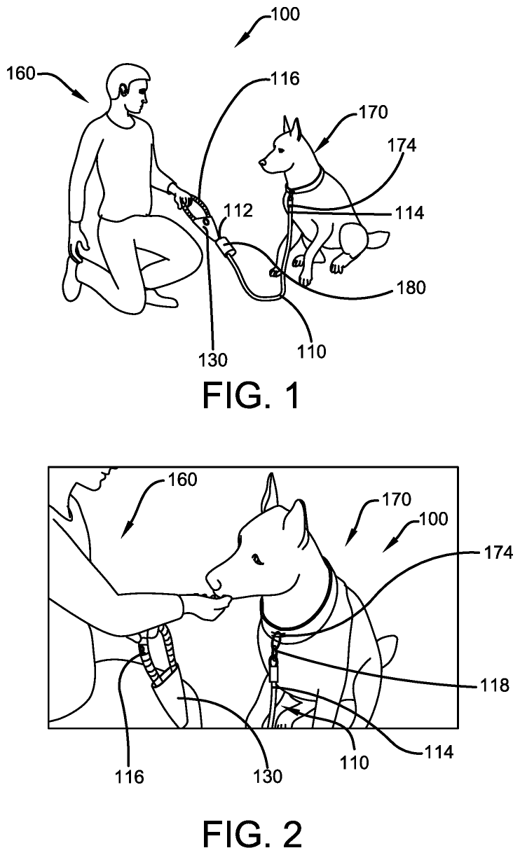

FIG. 1 illustrates a perspective view of a user 160 using one potential embodiment of the pet management system 100 of the present invention in accordance with the disclosed architecture and in relation to the training of a pet, such as a dog 170. More specifically, the pet management system 100 is comprised of a strip of material or leash 110 having a proximal end 112 and an opposing distal end 114, a handle 116, a collar connecting mechanism 118, a generally “V” shaped receptacle 130, and a sound emitting device 140. The handle 116 is positioned on the proximal end 112 of the leash 110 and is preferably in the general shape of a loop. By comparison, the collar connecting mechanism 118 is positioned on the opposing distal end 114 of the leash 110 for attaching the leash 110 to a pet collar 174.

The leash 110 may be extensible between a first and second length, for example, between 1 and 8 feet in length. The leash 110 is also preferably comprised of a durable, weather resistant material such as, but not limited to nylon, polyethylene, or other natural or synthetic materials. If the materials include elastic fibers, then the leash 110 can be easily stretched between a first position and a second position to accommodate the length needed between the owner 1690 and the pet 170. Alternatively, the owner 160 may wrap up the leash material around a loop or the handle 116, and dispense the extra material as is needed when taking the dog or other animal 170 for a walk. The loop or handle 116 may be comprised of a foam material so as to be compressible or soft for the owner 160 to grasp.

A portion of the loop shaped handle 116 further forms the generally “V” shaped receptacle 130 that has one or more pockets 132 therein to hold consumable products (e.g., dog treats), and other items (e.g., animal waste bags or accessories). The pockets 132 may further comprise any type of common closure mechanism such as, but not limited to, a zipper, flap, buckle, button, hook and loop fasteners, or the like. The receptacle 130 is also preferably comprised of a waterproof, or at least water resistant, material so as to keep the contents of the same safe and dry when, for example, the pet management system 100 is exposed to the elements, such as rain, snow or the like. In a preferred embodiment, the receptacle 130 is comprised of recycled materials.

The noise or sound emitting device 140 is preferably positioned along the handle, preferably adjacent to the “V” shaped receptacle, for convenient access by the pet owner and/or caretaker 160, and is useful in assisting the pet owner and/or caretaker 160 in the training and management of the animal. For example, the owner 160 may use the sound emitting device 140 to distract the dog 170 from engaging in unwanted behavior, or for other training purposes. The noise or sound emitting device 140 may be powered by a battery, a solar panel, a photovoltaic panel, or other suitable power source (not shown), or may be operated manually (e.g., a bell). If a battery is used, it may be a disposable battery or a rechargeable battery, and may be easily replaced or removed if necessary, for recharging. In one embodiment, the pet management device 100 contains a battery pack located in one of the pockets 132, and the batteries can be selected from disposable batteries or rechargeable batteries; preferably double-A sized batteries in sufficient quantity to provide power to the sound emitting device 140. Suitable batteries include alkaline, nickel-cadmium, nickel-metal hydride, etc.

In one embodiment, alternate power sources may also be used such as solar power cells electrically connected to solar panels (not shown) secured to the pet management device 100. More specifically, the solar panel will be charged during daylight and will provide power to the sound emitting device 140 throughout the day or night. Throughout this specification the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used.

In a further preferred embodiment, the pet management system 100 may comprise a waste management system 180, which may include a series of plastic or other bags to collect waste material from the pet, and potentially a scoop (not shown). The waste management system 180 may be connected to the handle portion 116, or elsewhere along the leash 110.

FIG. 2 illustrates a partial perspective view of the user using one potential embodiment of the pet management system 100 of the present invention in accordance with the disclosed architecture and in relation to the rewarding or feeding of the leashed pet 170 by the user 160. More specifically, the user 160 may store a plurality of, for example, pet treats 172 in one or more of the pockets 132 of the receptable 130. The pet treat 172 may be a reward for, by way of example, having responded to a command or the sound emitting device 140 as part of a training exercise. Further, as many pets tend to defecate shortly after consuming food, such as a pet treat 172, the waste management system 180 of the present invention may be used by the owner or pet caretaker 170 to clean up after the pet 170 in order to comply with local laws, ordinances or regulations.

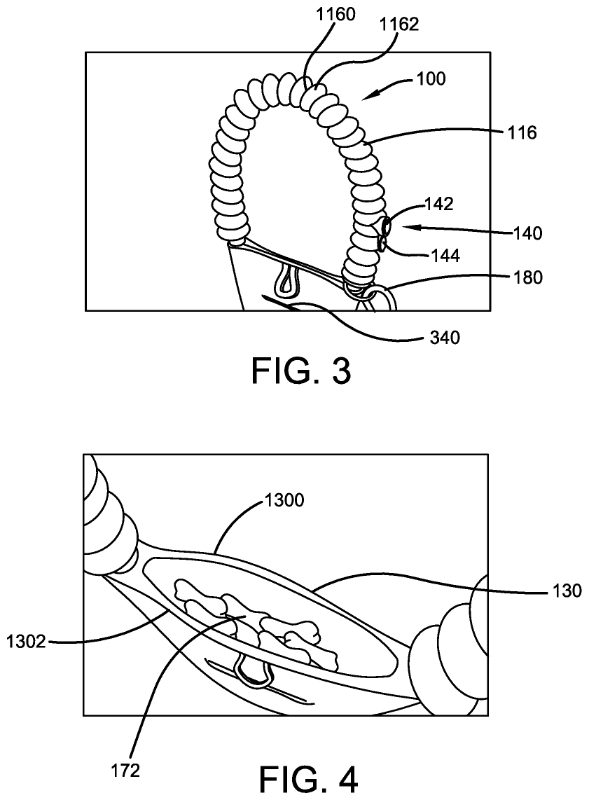

FIG. 3 illustrates a partial perspective view of one potential embodiment of the handle portion 116 of the pet management system 100 of the present invention in accordance with the disclosed architecture. More specifically, FIG. 3 illustrates the preferred positioning of the generally “V” shaped receptacle 130 and sound emitting device 140 in relation to the handle 116, which make is easier for the user 160 to access either with minimal effort. As shown, the handle 116 may have a plurality of alternating valleys 1160 and ridges 1162 for easier gripping by the user 160, but the same is not required and any typical configuration of handle 116 may be used to suit the needs and/or preferences of the user 160.

As best shown in FIG. 3, the noise or sound emitting device 140 may be integrated within the handle 116, easily in reach of the user's hand which will already have a firm grasp of the handle 116 to control the pet 170. As previously stated, the sound emitting device 140 is preferably powered by a battery (not shown) and is activated by the user pushing a button 142 thereon. Once activated, the sound emitting device 140 may make, for example, a squeaking or clicking sound that is emitted through a speaker 144 in order to distract the dog 170 or garner its attention to, for example, prevent the dog or pet from pulling on the leash 110 or engaging in other undesirable behavior. As also best shown in FIG. 3, the pet management system 100 may further comprise one of more rings 180 attached to the handle 116 or elsewhere along the lease. The rings 180 may serve as a convenient attachment point for additional accessories, such as the waste management system 150, keys, additional leashes, etc.

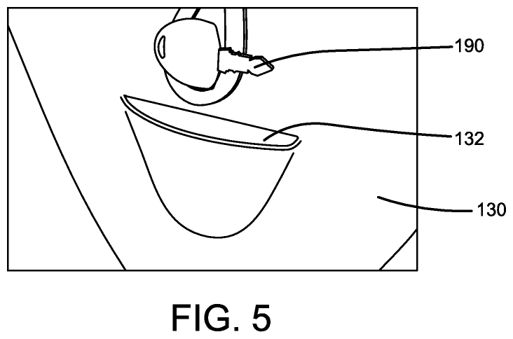

FIG. 4 illustrates a partial perspective view of one potential embodiment of the generally “V” shaped receptacle 130 of the pet management system 100 of the present invention in accordance with the disclosed architecture, and containing a plurality of dog treats 172. More specifically, receptacle 130 is formed by a pair of spaced apart walls 1300, 1302 and is convenient for storing items, such as treats 172. Receptacle 130 may further comprise a suitable closure mechanism (not shown) such as, but not limited to, a zipper, hook and loop fasteners, button, claps, resilient closures, or the like. In one or more of the first and second walls 1300, 1302, a further pocket 132 is provided, which may be sized and configured to fit various other accessories or requirements of the owner. For example, the pockets 132 may be used to hold keys, credit cards, currency, ID cards or the like, so that when the pet owner 160 is out walking his or her dog 170, he or she has easy access to these additional elements and does not have to go looking in a wallet or purse for the same. For example, FIG. 5 illustrates a partial perspective view of one potential embodiment of the second pocket 132 of the generally “V” shaped receptacle 130 of the pet management system 100 of the present invention in accordance with the disclosed architecture, and a key 190 being placed therein.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “receptacle” and “pocket” are interchangeable and refer to an improved system for holding a variety of items to implement the present invention.

Notwithstanding the forgoing, the components of the present invention can be of any suitable size and configuration as is known in the art without affecting the overall concept of the invention, provided that it accomplishes the above stated objectives. One of ordinary skill in the art will appreciate that the size, configuration and material of the improved pet management system as shown in the FIGS. are for illustrative purposes only, and that many other sizes of components of the pet management system are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet management device comprising:
a leash having a first end and a second end, wherein a handle is positioned at the first end and a connection device is positioned at the second end for attaching the pet management device to a collar of a pet;
a receptacle for transporting an item;
a sound emitting device; and
a waste management system.

2. The pet management device as recited in claim 1, wherein the receptacle is comprised of a first pocket and a second pocket.

3. The pet management device as recited in claim 1, wherein the sound emitting device is comprised of a button and a speaker.

4. The pet management device as recited in claim 1, wherein the sound emitting device is attached to the handle and is powered by a battery.

5. The pet management device as recited in claim 1, wherein the waste management system is comprised of a series of waste bags.

6. The pet management device as recited in claim 1, wherein the handle is comprised or a plurality of alternating ridges and valleys.

7. The pet management device as recited in claim 1, wherein the leash is extendable in length.

8. The pet management device as recited in claim 1, wherein the receptacle is comprised of a water resistant material.

9. The pet management device as recited in claim 1, wherein the receptacle is comprised of a closure mechanism.

10. The pet management device as recited in claim 1, wherein the receptacle is attached to the handle.

11. The pet management device as recited in claim 1, wherein the waste management system is attached to the leash.

12. The pet management device as recited in claim 1 further comprising at least one ring attached to the handle.

13. A domesticated pet leash device comprising:
a length of material having a proximal end and a distal end, with the proximal end having a handle and the distal end having a connection point to a collar for a pet;
the proximal end further comprising a “V” shaped receptacle disposed adjacent to the handle, with the “V” shaped receptable having a narrow end and a broader end, and the narrow end receiving the length of material and the broader end forming a base of a loop for the handle; and
the broader end having an opening with a closure and the “V” shaped receptacle having first and second walls.

14. The domesticated pet leash device as recited in claim 13, wherein one of the first and second walls has an opening sized and configured to receive one of a key, a credit card, an ID card or the like.

15. The domesticated pet leash device as recited in claim 13, wherein the broader end is sized and configured to receive a consumable food product.

16. The domesticated pet leash device as recited in claim 13, wherein the handle comprises a sound emitting device.

17. The domesticated pet leash device as recited in claim 13, wherein the handle is attached to a waste management system.

18. A pet training device comprising:
an extensible leash having a first end and a second end;
a receptacle having a first pocket and a second pocket;
a noise making device attached to the extensible leash; and
a waste management feature connected to one of the first and second ends.

19. The pet training device as recited in claim 18, wherein the extensible leash expands from a length of one foot to eight feet.

20. The pet training device as recited in claim 18, wherein the receptacle is adjacent the second end.
